(19) United States
(12) Patent Application Publication
(10) Pub. No.: US 2009/0195355 A1
(43) Pub. Date: Aug. 6, 2009

(54) METHODS AND APPARATUS FOR PLACE SHIFTING CONTENT TO A VEHICLE ENTERTAINMENT SYSTEM

(76) Inventor: Cynthia Sue Mitchell, Windsor, CO (US)

Correspondence Address: EchoStar Technologies, L.L.C.;Legal Department, 9601 SOUTH MERIDIAN BOULEVARD, ENGLEWOOD, CO, 80112, US

(21) Appl. No.: 12/024,391

(22) Filed: Feb. 1, 2008

(51) Int. Cl. G06F 7/04

(52) U.S. Cl. 340/5.8

(57) ABSTRACT

Apparatus, systems and methods are provided for transferring content from a home entertainment system to a vehicle entertainment system through a wireless connection. A user requests to experience content, through a vehicle entertainment system that is stored or otherwise made available through a content source that is located remotely with respect to the vehicle entertainment system. The vehicle entertainment system transmits a request to a base station communicatively coupled to the content source and the base station responsively retrieves the content from the content source and transmits the content over a wireless connection to the vehicle entertainment system.

### BACKGROUND

Advances in technology now provide users with large quantities of audio-visual (A/V) content available for listening and/or viewing. For example, cable and satellite television provide hundreds of television channels for viewing at any particular time. Digital video recorders (DVRs) permit the storage of recorded video content for on-demand viewing. DVRs, set-top boxes and personal computers facilitate the downloading of a diverse selection of music and videos from the internet. Movies and other A/V content can also be stored on optical disks, such as digital-video-disks (DVDs), for on-demand viewing. While users have a large selection of content available in their homes, it is somewhat more difficult to experience this large selection of content when the users are away from home. For example, content is significantly limited while users are riding in vehicles. While some vehicles are equipped with compact disk (CD) players or DVD players for presenting stored content to users, users must either acquire the content on an optical disk or take other steps to place the content on the disk before travel in the vehicle commences. Further, users must carry around physical disks in their vehicles in order to experience the content. This provides an inconvenience for users and further does not allow a user to spontaneously decide to experience content while in their vehicle or to receive content in real time as it is being streamed over one or more means of communication. Therefore, present vehicle entertainment systems do not provide the necessary flexibility to users for experiencing the full selection of content to the user available at home or other locations.

### BRIEF DESCRIPTION OF THE DRAWINGS

The same number represents the same element or same type of element in all drawings.

FIG. 1 illustrates an embodiment of a content transmission system.

FIG. 2 illustrates an embodiment of functional components of the vehicle entertainment system of FIG. 1.

FIG. 3 illustrates an embodiment of a screenshot of television programming displayed by the vehicle entertainment system of FIG. 2.

FIG. 4 illustrates an embodiment of a screenshot of a map displayed by the vehicle entertainment system of FIG. 2.

FIG. 5 illustrates an embodiment of a screenshot of selectable content sources displayed by the vehicle entertainment system of FIG. 2.

FIG. 6 illustrates an embodiment of a screenshot of an electronic programming guide displayed by the vehicle entertainment system of FIG. 2.

FIG. 7 illustrates an embodiment of a process for transferring content between a base station and a vehicle entertainment system.

FIG. 8 illustrates an embodiment of another process for transferring content between a base station and a vehicle entertainment system.

### DETAILED DESCRIPTION

The various embodiments described herein generally provide apparatus, systems and methods for transferring content from a home (or other relatively stationary, remote) entertainment system to a vehicle entertainment system through a wireless connection. A user may request to experience content, through a mobile, vehicle entertainment system, that is stored or otherwise made available through a content source that is located remotely with respect to the vehicle entertainment system. The vehicle entertainment system transmits a request to a base station communicatively coupled to the content source and the base station responsively retrieves the content from the content source and transmits the content over a wireless connection to the vehicle entertainment system. In short, various embodiments described herein provide apparatus, system and/or methods for place shifting content from a relatively stationary, remote base station to a mobile, vehicle entertainment system.

In at least one embodiment, the content to be received, processed, outputted and/or communicated may come in any of various forms including, but not limited to, audio, video, data, information, or otherwise. The vehicle entertainment system may comprise any device capable of receiving content over a wireless connection and responsively displaying the content to a user. For example, the vehicle entertainment system may include a display and/or speakers mounted within a vehicle that display audio, video or A/V content to a user.

In at least one embodiment, the base station is communicatively coupled to the internet or other type of data network over a wired or wireless connection. The vehicle entertainment system is further communicatively coupled to the internet or the data network over a wireless connection, such as cellular, WiFi or WiMax. Thus, the content transferred between the base station and the vehicle entertainment system is transmitted over the internet or the data network. In other embodiments, the base station and the vehicle entertainment system may be communicatively coupled over other data connections that are partially or fully wireless, such as a satellite connection. In at least one embodiment, the base station operates as a wireless access point for the vehicle entertainment system.

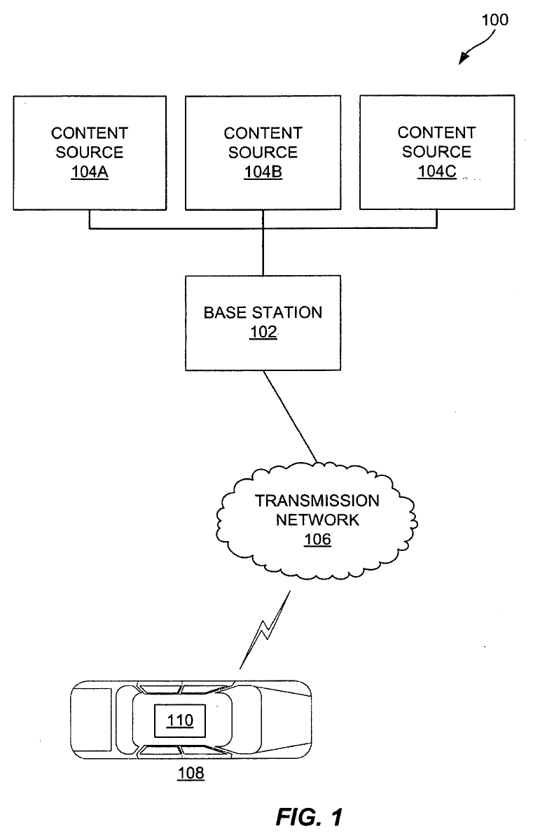

FIG. 1 illustrates an embodiment of a content transmission system 100. The content transmission system 100 transmits content between a base station and a vehicle entertainment system 110 for presentation to one or more users (not shown) within a vehicle 108. In at least one embodiment, the content presented to the user 108 includes an A/V stream, such as a television program, movie or other recorded or stored content and the like. However, it is to be appreciated that other content, such as audio content (e.g., music files), may be communicated from the base station 102 to the vehicle entertainment system 110. The content transmission system 100 includes a base station 102, a plurality of content sources 104A, 104B and 104C, a transmission network 106, a vehicle 108 and a vehicle entertainment system 110. Each of these components is discussed in greater detail below.

The base station 102 is communicatively coupled to one or more content sources 104A-104C and receives as input content from the content sources 104A-104C. In at least one embodiment, the base station 102 includes a multiplexer for selecting one of the content sources 104A-104C as input at any particular time. The base station 102 may be configured to receive as input content from any type of media source. Exemplary content sources include satellite or cable television set-top boxes, tuners or receivers, terrestrial television tuners, DVRs, personal computers, DVD players, DVD jukeboxes, optical disk players, music servers, video servers, VCRs, digital cameras, video recorders and the like.

The base station 102 and the content sources 104A-104C may be communicatively coupled over any type of wired or wireless connection. For example, the base station 102 may be communicatively coupled to a satellite television set-top box through a coaxial cable or High Definition Multimedia Interface (HDMI) cable. The base station 102 may also be communicatively coupled to a satellite television set-top box or other A/V device using component cables, an Ethernet connection, a WiFi connection or Bluetooth connection and the like. In at least one embodiment, one or more content sources 104A-104C may be integrated With the base station 102. For example, the base station 102 may include a cable television tuner, satellite television tuner or an over-the-air television tuner. The base station 102 may also include an integrated DVR or other content storage device.

In at least one embodiment, the base station 102 is capable of receiving audio and/or video signal(s) in any type of analog or digital format. From the received audio and/or video signal, the base station 102 constructs a media stream that is suitable for transmission over the transmission network 106 to a client device (e.g., the vehicle entertainment system 110). If necessary, the base station 102 digitizes and compresses the content into a transmittable A/V signal, such as Windows Media Video, MPEG-2, MPEG-4, MPEG-7, MP3 and the like. The digitizing process may be performed by an A/V encoder of the base station 102. For example, the base station 102 may receive a baseband signal from the content source 104A and responsively translate the baseband signal into an MPEG-4 video stream.

In at least one embodiment, the base station 102 is operable to transmit commands to the content sources 104A-104C to control the output of content from the content sources 104A-104C. Thus, a user is capable of controlling, in real time, the live output of the content sources 104A-104C, via the base station 102, from any client device communicatively coupled to the base station 102 through any type of network. In at least one embodiment, the base station 102 may include an IR blaster or the like that transmits IR codes to a content source 104A-104C. For example, a user may send control commands (e.g., “channel up”) from a client device (e.g., the vehicle entertainment system 110) over the network 106 to the base station 102 to be communicated to and executed by a content source 104A-104C. Thus, the content source 104A-104C changes the output of content responsive to the control commands received from the vehicle entertainment system 110.

After the transport stream of the content is constructed, the base station 102 transmits the content to the transmission network 106 for transmission to the vehicle entertainment system 110. The base station may be communicatively coupled to the transmission network 106 through any type of wired or wireless communication link. For example, the base station 102 may be coupled to an internet gateway of the transmission network 106 over a local area network (LAN). The transmission network 106 may comprise any suitable networking technology, including wide area mobile networks (e.g., General Packet Radio Service (GPRS), Enhanced Data Rates for GSM Evolution (EDGE), 1X-RTT, 1x-EvD and Freedom of Mobile Multimedia Access (FOMA) 2.5G and 3G cellular networks), WiFi and other public broadband access locations, WiMax networks and satellite broadband networks.

In other embodiments, the base station 102 may be directly connected to the transmission network 106 through a wired or wireless connection. For example, the base station 102 may be communicatively coupled to a broadband cellular network, a satellite broadband network or a WiMax network. Thus, the transmission network 106 provides broadband data transfer between the base station 102 and the vehicle entertainment system 110. The base station 102 and the vehicle entertainment system 110 may communicate using various networking protocols including hyper text transfer protocol (HTTP) over transmission control protocol/internet protocol (TCP/IP), as well as user datagram protocol (UDP), real time streaming protocol (RTSP), real-time transport protocol (RTP), resource reservation protocol (RSVP), and the like.

The vehicle entertainment system 110 may comprise any device mounted within a vehicle 108 that is capable of wirelessly receiving and presenting content to a user. Exemplary vehicles include automobiles, motor homes, motorcycles, boats, other watercraft and airplanes. In at least one embodiment, the vehicle entertainment system 110 may include a media player software application that is configured to receive streaming content transmitted by the base station 102. The vehicle entertainment system 110 is communicatively coupled to the transmission network 106 over a wireless connection. For example, the vehicle entertainment system 110 may include a wireless receiver that receives data from the transmission network 106 over a cellular communication link, satellite communication link, WiFi or WiMax communication link and the like.

In at least one embodiment, the vehicle entertainment system 110 comprises a vehicle navigation system or the like. In other embodiments, the vehicle entertainment system 110 may comprise a DVD player, television system and the like that includes an integrated or external RF receiver for receiving content from the base station 102 through the transmission network 106.

The vehicle entertainment system 110 may include a touch screen that displays the received content as well as allows the user to provide input to the vehicle entertainment system 110. For example, the user may select content to be presented by the vehicle entertainment system 110 by providing input via the touch screen of the vehicle navigation system. Responsive to receiving the input, the vehicle navigation system transmits a request to the base station 102 over the transmission network 106. The base station 106 receives the requested content from one or more content sources 104A-104C and responsively transmits the content to the vehicle entertainment system 110. The vehicle entertainment system 110 presents the received content to a user within the vehicle 108. For example, the vehicle entertainment system 110 may display received video content on one or more display screens within the vehicle 108. Similarly, the vehicle entertainment system 110 may output received audio content on speakers of the vehicle 108 or to one or more headphones communicatively coupled to the vehicle entertainment system 110. In some embodiments, the vehicle entertainment system 110 may include other input devices, such as remote controls, keyboards, mice, dials, buttons and the like that allow a user to provide input to the vehicle entertainment system 110.

In at least one embodiment, the vehicle entertainment system 110 connects to the base station 102 over an IP connection by accessing the IP address of the base station 102. Most residential ISPs allocate dynamic IP addresses via dynamic host configuration protocol (DHCP), as opposed to providing static IP addresses. Thus, there may be a need for a central domain name system (DNS) server that allows the vehicle entertainment system 110 to locate and access the base station 102. The transmission network 106 may include a central server (not shown) that provides DNS service. In at least one embodiment, the central server assigns the base station 102 a DNS name (e.g., username1.basestation.com), and correlates the assigned DNS name to the IP address of the base station 102. To account for the dynamic nature of the IP address, the base station 102 may include a dynamic DNS client application that reports any changes to the IP address of the base station 102 to the central server of the transmission network 106. Thus, the central server of the transmission network 106 may facilitate connecting the vehicle entertainment system 110 to the base station 102 even if the IP address of the base station 102 changes.

In at least one embodiment, the base station 102 may be a media broadcaster, such as a SLING MEDIA® SLING BOX® or the like.

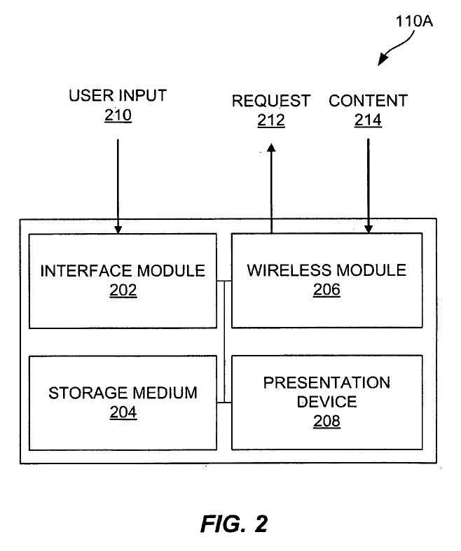

FIG. 2 illustrates an embodiment of functional components of an exemplary vehicle entertainment system 110A of FIG. 1. FIG. 2 will be discussed in reference to the content transmission system 100 illustrated in FIG. 1. The vehicle entertainment system 110A includes an interface module 202, a storage medium 204, a wireless module 206 and a presentation device 208. Each of these components is discussed in greater detail below.

The interface module 202 is configured to receive user input 210 from a user. The user input 210 requests presentation of content 214 from a content source 104A-104C located remotely with respect to the vehicle entertainment system 110A. In other words, the user input 210 requests streaming of content from a content source 104A-104C to the vehicle entertainment system 110 via the base station 104 and the transmission network 106. The user input 210 may additionally manipulate presentation of the content 214 by the vehicle entertainment system 110A. For example, the user input 210 may change the channel of television programming, change the volume of content or perform other trick play mode functions on the content (e.g., fast forwarding, reversing, pausing, chapter skipping and the like).

In at least one embodiment, the interface module 202 comprises a touch screen integrated with the presentation device 208 of the vehicle entertainment system 110A. The interface module 202 may also comprise an infrared (IR) or (RF) receiver for receiving the user input 210.from a remote control, mobile communication device or other wireless input device. In at least one embodiment, the interface module 202 comprises an input port for connecting to a keyboard, mouse, steering wheel controls or other wired input device. Responsive to the request 212, the content source 104A outputs the content 214 for transmission to and presentation by the vehicle entertainment system 110. The user input 210 may also request trick play mode presentation functions (e.g., fast forwarding, reversing, pausing, chapter skipping and the like) to be performed on the content 214. In other words, the user input 210 may request temporal movement through the content 214 at rates that are different than the real-time presentation rate of the content 214.

In at least one embodiment, the interface module 202 comprises a microphone that receives the user input 210 as part of a voice command. For example, a user may speak into the microphone, requesting the presentation of a television program (VOD or other programming) from a specified channel provided through a satellite receiver communicatively coupled to the base station 102. The interface module 202 may utilize voice recognition techniques to generate a request 212 compatible with the base station 102 based on the voice command.

The storage medium 204 stores authentication information of the user for the base station 104. The authentication information is utilized by the vehicle entertainment system 110A to access the base station 102 and request streaming of the content 214 from the content sources 104A-104C to the vehicle entertainment system 110A. The authentication information may include any type of information utilized by a user to access a secure base station 102, such as a username/password, access code, personal identification number (PIN), digital certificate and the like. The storage medium 204 may comprise any type of non-volatile memory device, such as flash memory, hard drives and the like. The storage medium 204 may be further utilized for the temporary or permanent storage of content 214 received from the base station 104. For example, the storage medium 204 may be adapted to buffer the content 214 received from the base station 104 or to store the content 214 for subsequent presentation to a user.

The wireless module 206 is operable to communicate with the base station 102 via the transmission network 106. More particularly, the wireless module 206 is communicatively coupled to the transmission network 106 over a wireless communication link. Responsive to the user input 210 received by the interface module 202, the wireless module 206 transmits a request 212 for the content 214 to the base station 102. In at least one embodiment, the request 212 may include the authentication information for the base station 102.

To make the authentication process easier for a user, the vehicle entertainment system 110A may be operable to automatically include the authentication information in the request 212. For example, the user may press a button on a touch screen of the interface module 202 requesting to view content stored on a DVR communicatively coupled to the base station 102. The wireless module 206 generates a request including the authentication information and transmits the request to the base station 102. Responsive to the request 212, upon verification of the authentication information, the base station 102 retrieves the content 214 from one or more content sources 104A-104C and transmits the content 214 to the vehicle entertainment system 110(A) over the transmission network 106.

The presentation device 208 is operable to present the received content 214 to a user. The presentation device 208 may comprise any type of device capable of presenting audio, video, data and/or A/V content to a user. For example, the presentation device 208 may comprise a vehicle navigation system with a display screen, a touch screen display, a seat mounted display screen or ceiling mounted display screen and the like. In at least one embodiment, the presentation device 208 comprises speakers or headphone jacks of a vehicle that emit audible reproductions of the received content 214.

In at least one embodiment, the content 214 being requested may include one or more internet games.

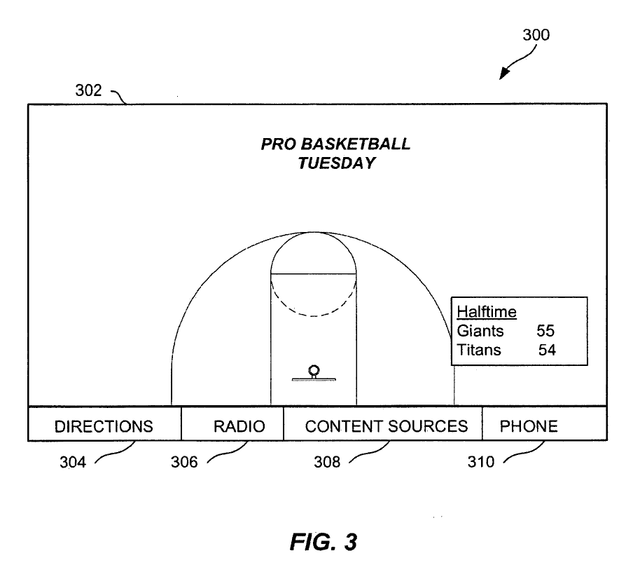

FIG. 3 illustrates an embodiment of a screenshot 300 of television programming displayed by the vehicle entertainment system 110A of FIG. 2. More particularly, the screenshot 300 is presented by a navigation system of the vehicle 108 (see FIG. 1). FIG. 3 will be discussed in reference to the content transmission system 100 illustrated in FIGS. 1-2.

The screenshot 300 displays television programming 302 (i.e., streaming video of a basketball game). The screenshot 300 further includes a series of buttons 304-310 disposed along a bottom edge of the screenshot 300. The button 304 allows a user to access directions and maps provided by a vehicle navigation system. The button 306 allows a user to access the radio of the vehicle 108. The button 308 allows the user to initiate streaming of content from different content sources 104A-104C located remotely with respect to the vehicle entertainment system 110. The button 310 allows a user to access a mobile telephone communicatively coupled to the vehicle entertainment system 110A.

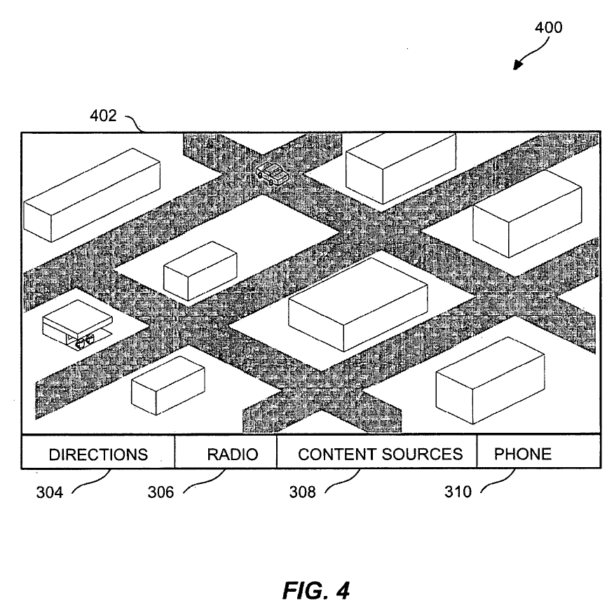

FIG. 4 illustrates an embodiment of a screenshot 400 of a map 402 displayed by the vehicle entertainment system 110A of FIG. 2. FIG. 4 will be discussed in reference to the content transmission system 100 illustrated in FIGS. 1-2. A user may access the map 402 using the button 304 of the screenshot 300, a button on the steering wheel or the like. Because the vehicle entertainment system 110A can be placed within a vehicle navigation system already present in many vehicles, the additional physical components needed to implement the vehicle entertainment system 110A are minimal. For example, many vehicle navigation systems already include speakers, touch screen displays and RF receivers which may be utilized for implementation of the vehicle entertainment system 110A. Many vehicle navigation systems may also include a wireless module 206 for receiving updates to local maps or business information via a satellite communication link, cellular network or the like. Many vehicle entertainment systems may include a wireless module for communicating with emergency personnel the location of the vehicle in the event that the air bags (not shown) deploy, via a satellite, cellular or other wireless communication network system.

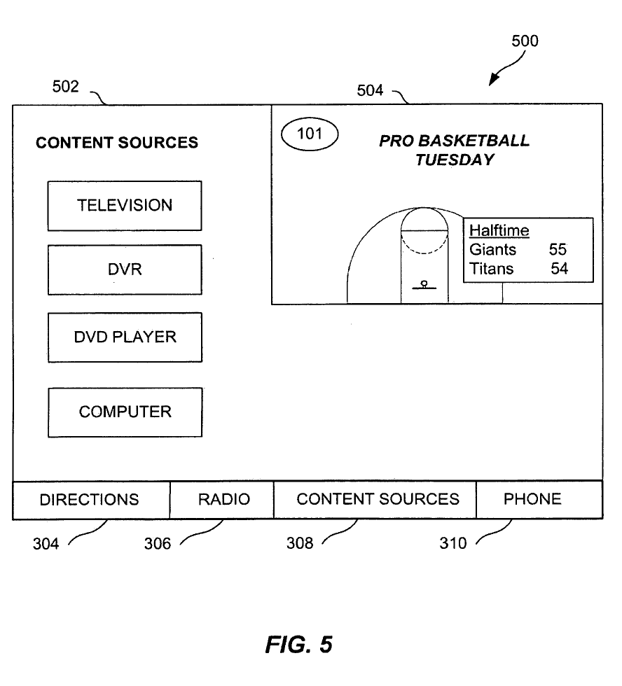

FIG. 5 illustrates an embodiment of a screenshot 500 of selectable content sources displayed by the vehicle entertainment system 110A of FIG. 2. FIG. 5 will be discussed in reference to the content transmission system 100 illustrated in FIGS. 1-2. The screenshot 500 includes a list 502 of content sources 104A-104C located remotely with respect to the vehicle entertainment system 110A from which a user can select to stream content to the vehicle entertainment system 110A. The user can access screenshot 500 using the button 308 of FIG. 3.

The screenshot 500 further includes a preview window 504 displaying the last content viewed by a user on the vehicle entertainment system 110A. For example, in FIG. 3, the user was watching a basketball game on channel 101 of a satellite television broadcast system. Thus, when the user enters screenshot 500, the preview window 504 continues to display the basketball game to the user.

A user may utilize one of the content source buttons to switch the source of content streaming from the base station 102 to the vehicle entertainment system 110A. Responsive to user input selecting one of the content sources, the wireless module 206 transmits a command to the base station 102 selecting content from one of the content sources 104A-104C communicatively coupled to the base station 102. For example, a user may be watching content streaming from a satellite television receiver communicatively coupled to the base station 102, and may subsequently desire to watch streaming content from a DVR communicatively coupled to the base station 102. After pressing one of the content source buttons in screenshot 500, the user may be presented with additional menus that allow the user to further refine the selection of content that they desire to view. For example, a user may select the television button of screenshot 500 and may be subsequently presented with an electronic programming guide (EPG) from which to select a particular television program or channel to view.

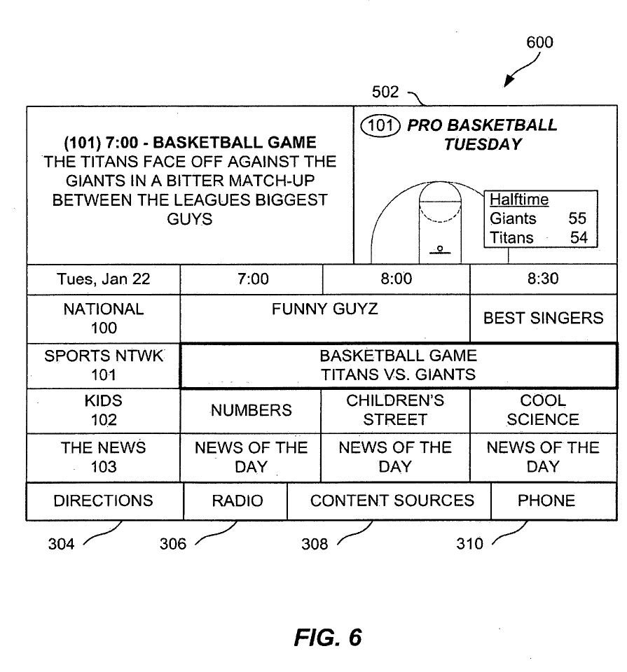

FIG. 6 illustrates an embodiment of a screenshot 600 of an electronic programming guide displayed by the vehicle entertainment system 110A of FIG. 2. FIG. 6 will be discussed in reference to the content transmission system 100 illustrated in FIGS. 1-2. A user may utilize the electronic programming guide to change the channel displayed by the vehicle entertainment system 110A. The electronic programming guide displays a grid of the various channels of the satellite television broadcast system from which the user can select to view television programming. The user may navigate the grid of television programming using navigation buttons displayed on the touch screen, buttons disposed on the steering wheel of the vehicle 108 or using any other type of input device. While the user views the electronic programming guide, the screenshot 600 presents the user with a preview window 504 of the last watched television program (e.g., the basketball game of FIG. 3).

Once the user identifies a program of interest, they may provide input in order to select the program for streaming from the base station 104 to the vehicle entertainment system 110A. Responsive to the user input, the wireless module 206 transmits a command to the base station 102 requesting streaming of the selected television programming. If the selected content source 104A-104C is not presently outputting the desired content, then the base station 102 may transmit a command to the selected content source 104A-104C to control the content outputted by the content source 104A-104C. The base station 102 then captures the outputted content from the content source 104A-104C and streams the content to the vehicle entertainment system 110A for presentation to a user.

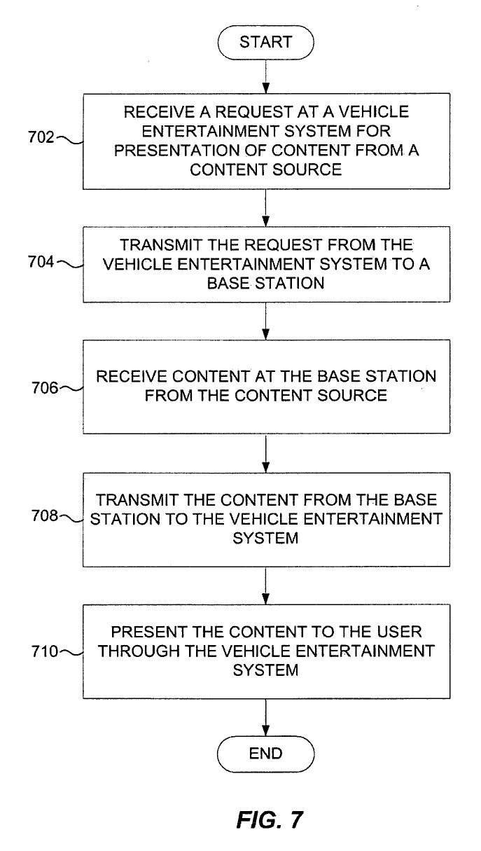

FIG. 7 illustrates an embodiment of a process for transferring content between a base station and a vehicle entertainment system. More particularly, FIG. 7 illustrates a process for streaming content to a vehicle entertainment system from one or more content sources located remotely with respect to the vehicle entertainment system. The operations of the process of FIG. 7 are not all-inclusive, and may comprise other operations not illustrated for the sake of brevity.

The process includes receiving a request from a user, at a vehicle entertainment system, requesting presentation of content from at least one content source located remotely with respect to the vehicle entertainment system (operation 702). The request may be inputted to the vehicle entertainment system by the user using any type of input device, including a touch screen, keyboard, microphone and the like.

The process further includes transmitting the request to a base station located remotely with respect to the vehicle entertainment system (operation 704). In at least one embodiment, the request includes authentication information of the user for the base station. For example, the authentication information may include the user's access code for the base station. The request may be transmitted to the base station from the vehicle entertainment system over any type of transmission network that is at least partially wireless. For example, the vehicle entertainment system may transmit the request over an IP connection provided over a cellular or satellite network, and the request may be further transmitted to the base station over a wired digital subscriber line (DSL) or other broadband connection.

The process further includes receiving selected content at the base station, from at least one content source, responsive to the base station receiving the request from the vehicle entertainment system (operation 706). For example, the request may indicate that a user desires to watch a channel from a satellite television broadcast system. Thus, the base station may manipulate a multiplexer or other switching device to initiate reception of content from a satellite television receiver.

The process further includes transmitting the content wirelessly from the base station to the vehicle entertainment system (operation 708). In at least one embodiment, the transmission of the content may be performed through an IP network. For example, the base station may transmit the content to the internet over a wired broadband network. The vehicle entertainment system may be communicatively coupled to the internet over a cellular or satellite broadband connection, and thus, may receive the content from the internet over the wireless broadband communication link.

The process further includes presenting the content to the user through the vehicle entertainment system (operation 710). For example, the received content may be a video stream, and the vehicle entertainment system may responsively display the streaming video on a display screen in a vehicle. Thus, the user enjoys video content in their vehicle that is normally experienced within their home without bringing the content to the vehicle on physical storage mediums.

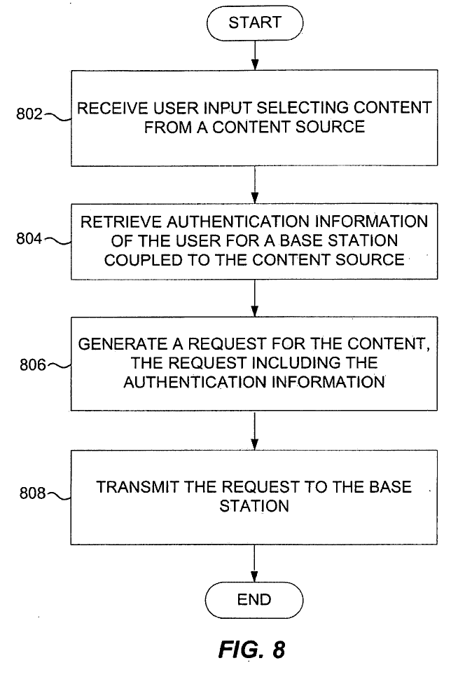

FIG. 8 illustrates an embodiment of another process for transferring content between a base station and a vehicle entertainment system. More particularly, FIG. 8 illustrates a process for transmitting a request for streaming content from a vehicle entertainment system to a base station communicatively coupled to a content source located remotely with respect to the vehicle entertainment system. The operations of the process of FIG. 8 are not all-inclusive, and may comprise other operations not illustrated for the sake of brevity.

The process includes receiving user input selecting content from one or more content sources (operation 802). For example, the vehicle entertainment system may present the user with a menu illustrating content sources coupled to the base station. Additional menus may be presented to the user that illustrate various content available for streaming from each of the content sources (e.g., an electronic programming guide of television programs). In at least one embodiment, the menus may be generated and/or presented by the vehicle entertainment system based on information provided by the base station and/or the content sources.

The process further includes retrieving authentication information of the user for the base station (operation 804). The process further includes generating a request for the content, the request including the authentication information (operation 806). In at least one embodiment, the vehicle entertainment system automatically includes the authentication information in the request responsive to user input selecting to stream content from the base station to the vehicle entertainment system. For example, a user selects, from the vehicle entertainment system, to view a channel of the satellite television system, and the vehicle entertainment system automatically includes the user's authentication information with the request transmitted to the base station. Thus, the user does not need to worry about providing their authentication information every time they stream content to the vehicle entertainment system from the base station.

The process further includes transmitting the request from the vehicle entertainment system to the base station (operation 808). Operation 808 may be performed similarly as described in operation 708 of FIG. 7. Responsive to the request, the base station streams the content from the selected content source to the vehicle entertainment system for presentation to the user.

Although specific embodiments were described herein, the scope of the invention is not limited to those specific embodiments. The scope of the invention is defined by the following claims and any equivalents therein.

1. A method for transferring content between a base station and a vehicle entertainment system, the method comprising:
receiving a request from a user, at a vehicle entertainment system, requesting presentation of content, from at least one content source, located remotely with respect to the vehicle entertainment system;
transmitting the request to a base station, the request including authentication information of the user for the base station;
receiving the content, at the base station, from the at least one content source, responsive to the base station receiving the request from the vehicle entertainment system;
transmitting the content wirelessly, from the base station, to the vehicle entertainment system; and
presenting the content to the user through the vehicle entertainment system.

2. The method of claim 1, wherein transmitting the request further comprises:
automatically including the authentication information in the request, the authentication information being stored in the vehicle entertainment system.

3. The method of claim 1, wherein transmitting the request to the base station further comprises;
transmitting a command from the vehicle entertainment system to the base station, the command selecting content from one of a plurality of content sources communicatively coupled to the base station.

4. The method of claim 1, wherein transmitting the content wirelessly, from the base station, to the vehicle entertainment system, further comprises:
converting the content from an analog format to a digital format.

5. The method of claim 1, wherein the content comprises video content.

6. The method of claim 1, wherein the content comprises audio content.

7. The method of claim 1, wherein the vehicle entertainment system comprises a vehicle navigation system.

8. The method of claim 1, further comprising:
transmitting a command from the vehicle entertainment system to the base station, the command controlling an output of the at least one content source; and
transmitting the command from the base station to the at least one content source.

9. A vehicle entertainment system comprising:
an interface module that receives a request from a user requesting presentation of content from at least one content source located remotely with respect to the vehicle entertainment system, the at least one content source communicatively coupled to a base station;
a storage medium that stores authentication information of the user for the base station;
a wireless module communicatively coupled to the storage medium that transmits the request to the base station, the wireless module automatically including the authentication information of the user with the request, the wireless module further operable to receive the content from the base station; and
a presentation device communicatively coupled to the wireless module that presents the content to the user.

10. The vehicle entertainment system of claim 9, wherein the content comprises video content.

11. The vehicle entertainment system of claim 9, wherein the content comprises audio content.

12. The vehicle entertainment system of claim 9, wherein the presentation device comprises a display screen of a vehicle navigation system.

13. The vehicle entertainment system of claim 9, wherein the interface module comprises a touch screen that displays a menu of available content on the at least one content source, and wherein the user inputs the request to the vehicle entertainment system using the touch screen.

14. The vehicle entertainment system of claim 9, wherein the wireless module transmits a command to the base station, wherein the base station transmits the command to the at least one content source, the command controlling an output of the at least one content source.

15. A system comprising:
a base station communicatively coupled to at least one content source;
a vehicle entertainment system that receives a request from a user for presentation of content from the at least one content source that is located remotely with respect to the vehicle entertainment system, the vehicle entertainment system further operating to transmit the request to the vehicle entertainment system, the request including authentication information of the user for the base station;
wherein the base station is operable to:
receive the request from the vehicle entertainment system;
authenticate the user based on the authentication information;
transmit a command to control the output of the content by the at least one content source;
receive the outputted content from the at least one content source; and
transmit the content to the vehicle entertainment system;
wherein the vehicle entertainment system receives the content from the base station and presents the content to a user.

16. The system of claim 15, wherein the vehicle entertainment system automatically includes the authentication information with the request, the authentication information being stored in the vehicle entertainment system.

17. The system of claim 15, wherein the vehicle entertainment system comprises a touch screen that displays a menu of available content on the at least one content source, and wherein the user inputs the request to the vehicle entertainment system using the touch screen.

18. The vehicle entertainment system of claim 15, wherein the content comprises video content.

19. The vehicle entertainment system of claim 15, wherein the content comprises audio content.

20. The vehicle entertainment system of claim 15, wherein the base station and the vehicle entertainment system communicate through a cellular transmission network.

21. The vehicle entertainment system of claim 15, wherein the base station and the vehicle entertainment system communicate through a satellite transmission network.
